(19) United States
(12) Patent Application Publication
(10) Pub. No.: US 2003/0064736 A1
(43) Pub. Date: Apr. 3, 2003

(54) Text entry method and device therefor

(75) Inventors: Matthew J. Bickerton, Bletchingly (GB); David P. Walker, Redhill (GB); Bruce Duncan, Bracknell (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/152,115

(22) Filed: May 21, 2002

(30) Foreign Application Priority Data
May 25, 2001 (GB) 0112870.1

(51) Int. Cl. H04Q 7/20

(52) U.S. Cl. 455/466; 455/550

(57) ABSTRACT

A device and method providing improved text entry via touch input means are described. The touch input means is labelled so as to provide a keypad, the keypad itself comprising key regions (206) which each depict a primary character surrounded by other characters. To enter text the user touches the key region (206) associated with the character required, and then moves the touch input in the direction of the required character. The method comprises the steps of defining a trajectory (312) comprising a plurality of location points (313) in response to the touch input; analysing the trajectory to determine a predominant direction and a representative location (206) of the trajectory; and selecting a character for input depending on the location and direction of the trajectory.

### FIELD OF INVENTION

The present invention relates generally to a method of entering text into a device, and in particular to a device such as a portable radio telephone or a handheld computer.

### BACKGROUND OF INVENTION

The immense growth in portable radio telephone, or “mobile phone” ownership during recent years has been well documented and reported world-wide. Whilst mobile phone networks, such as the Global System for Mobile communications (GSM) were originally designed for voice traffic, the sending of text messages using a Short Messaging Service (SMS) via such phones has risen dramatically over the past couple of years, with the number of SMS messages sent world-wide on the GSM network(s) reaching 15 billion in December 2000. This is in part due to the critical mass of ownership now reached in developed countries, and also due to the low and typically fixed cost of sending a text message when compared with a voice call. The number of text messages sent are forecast to increase even further with the impending introduction of more advanced, so called ‘3G’ (third generation) wireless networks and services, where data, fax and email will be available on a 3G mobile phone or suitably equipped handheld computer or personal digital assistant (PDA).

A known method of entering text into such devices involves pressing a key on a keypad several times, to cycle through characters associated with that key, until the character required by a user is selected. This requires many key presses per word and is slow and prone to error.

### OBJECT OF INVENTION

It is therefore an aim of the present invention to provide an improved method of entering text into a device.

### SUMMARY OF INVENTION

According to a first aspect of the present invention there is provided a method for the selection of an input character to a device comprising touch sensitive input means; said method comprising the steps of:

defining a trajectory comprising a plurality of location points in response to touch input;

analysing the trajectory to determine a predominant direction and a representative location of said trajectory; and

selecting a character for input depending on the location and direction of said trajectory.

According to a second aspect of the present invention there is provided a device for receiving character input comprising:

touch sensitive input means;

means for defining a trajectory comprising a plurality of location points in response to touch input;

analysis means for analysing the trajectory to determine a predominant direction and a representative location of the trajectory; and

character selection means responsive to the determined location and direction for determining an input character.

The touch input is generally created by a user applying fingertip or thumb pressure to the touch sensitive input means. A preferred location for the touch sensitive input means is within, or on a surface of, the device.

The method and device of the present invention provide a user input consisting typically of a simple touch, slide and lift gesture on the touch input means, the gesture on average lasting about an eighth of a second. The trajectory analysis provides a robust and tolerant determination of the character the user intends to select, thereby enabling a quick and accurate character input.

In one embodiment of the present invention the complete English alphabet and up to twenty two other commonly used punctuation, or other symbol characters can be displayed on a small, mobile phone sized keypad.

In a further embodiment of the present invention, a method provides accurate character selection tolerant to initial finger placement, particularly advantageous given the limited area available for a keypad on a mobile phone or other portable device.

In another embodiment of the present invention a key arrangement can be stored and displayed on a touchscreen, thereby offering a graphical representation of a keypad to the user. The combination of a stored key arrangement and a touchscreen together acting as a keypad allows the possibility of user customisation of the key arrangement to the user's own preferences.

A further embodiment of the present invention allows the trajectory and location analysis to take into account whether the user is right handed or left handed, thereby improving the accuracy of character selection and providing personal customisation.

In yet a further embodiment of the present invention there is provided a method of modifying a previously selected character to a related character, thereby expanding the number of accessible characters selectable for input. Advantageously the related characters comprise accented characters (for example the character é related to a first selection of e), or symbols (punctuation) and combinations of symbols which represent emote icons (commonly referred to as “smileys”, for e.g. [symbol] [symbol] :-D ), hence providing a user with an intuitive method of modifying characters to related characters according to a method of this invention.

The method and device of this invention provide improved text entry, particularly suited to, but not exclusively for, handheld devices such as portable mobile radio telephones, personal digital assistants, pocket computers and remote control handsets. The invention may also be applied to devices such as laptop computers, public email or information terminals and any other device where the advantages of fast, intuitive and accurate character selection are required.

### BRIEF DESCRIPTION OF DRAWINGS

Embodiments of the present invention will now be described, by way of example only, with reference to the accompanying figures in which:

FIG. 1 depicts a known mobile phone keypad.

FIG. 2 depicts an example of a key arrangement for use with the present invention, wherein the complete A-Z English alphabet and 22 other characters are visible and accessible.

FIG. 3 shows an example trajectory traced by a user's fingertip when selecting a character.

FIG. 4 depicts an example of a radio telephone device made in accordance with the present invention.

FIG. 5 is a block schematic diagram of the device shown in FIG. 4.

FIG. 6 illustrates a key region co-ordinate system used to define key regions.

FIG. 7 schematically depicts typical trajectories input by a right handed user when selecting characters by a method of this invention.

FIG. 8 Is a flow diagram illustrating a basic implementation of a method according to the present invention.

FIG. 9 is a front schematic view of a handheld computer provided with a touchscreen, the touchscreen displaying a key arrangement for use with a method according to the present invention.

In the figures the same reference numerals have been used to indicate corresponding features.

### DETAILED DESCRIPTION

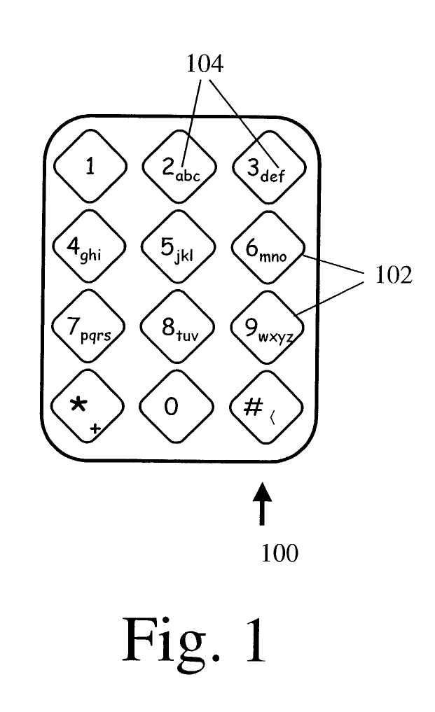

FIG. 1 shows a keypad 100 of the kind found on a mobile phone. A known method of entering text messages into the mobile phone involves pressing a key 102 on the keypad several times to cycle through alphanumeric characters 104 associated with that key. For example, a user wishing to enter the word “hello” would be required to press key “4” twice for “h”, key “3” twice for “e”, key “5” three times for “l”, again key “5” three times for “l” and finally key “6” three times for “o”. This method of text entry results in a total of thirteen key presses to enter a common five letter English word. Similarly, a total of twenty six key presses are required to enter the phrase “where are you”, an average of two key presses per character (including spaces). The addition of a question mark character, “?”, to the phrase would result in several more key presses.

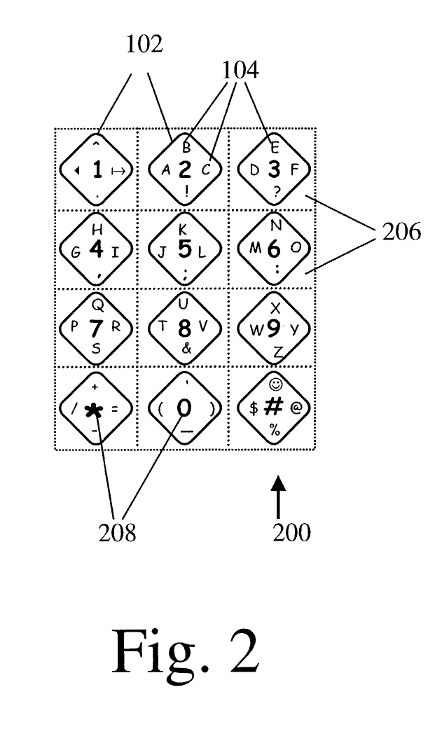

A keypad suitable for use in accordance with the present invention is shown in FIG. 2, comprising twelve keys 100 arranged in four rows, each row comprising three keys, in a similar fashion to the keypad 100 shown in FIG. 1. A respective key region 206 is defined in the vicinity of each key 104, the total key arrangement 200 therefore comprising twelve key regions. The key regions 206 in this embodiment are rectangular in shape, and extend beyond the boundary of the key 102 contained within the key region 206. Of course, the key regions may be any shape suitable for the key design and keypad depending upon the intended device and application. In this embodiment, suited to a mobile phone application, ten of the key regions 206 are assigned as a primary character 208 the digits zero to nine, and the remaining two key regions are assigned as a primary character * (star) and # (hash).

In addition to displaying a primary character (0-9, * or #) in the centre of each key region 206, each key region 206 is also assigned characters 104 which are displayed around the periphery of each key region. For example, the key region 206 assigned primarily to the character “7”, may depict a relatively large “7” in the centre of the key region, and in smaller text size, the characters P, Q, R, and S to the left, top, right and bottom of the central character as shown in FIG. 2. In this manner the complete alphabet A-Z and twenty two extra characters, for example a period “.”, an exclamation mark “!”, or even an entire “smiley” [symbol] are able to be displayed on a four by three key arrangement 200 suitable for use with a mobile phone.

To enter text into a device made in accordance with the present invention, the user slides a fingertip towards a key region 206 associated with the required character, and then slides the fingertip in the direction of the character required, and finally removes the finger to select the required character for input.

The method according to the present invention comprises performing the action of defining a trajectory based on the input prior to the removal of the fingertip, and analysing the trajectory to determine a representative location and a predominant direction. A character is then selected for input based on the key region within which the representative location falls, and the direction. In this example the character associated with the key region 206 having “7” as a primary character and direction “left” is the character “P”.

To enter the primary characters 208 (e.g. 0-9, # or *), a quick tap on the key region required is performed, a “no direction” for the trajectory is determined and the primary character is selected for input.

The actual distance travelled by the user's fingertip is typically only a few millimeters, depending upon the design and size of the key arrangement 200, and the size of the user's finger or thumb or other such pointing means used for input. It is the analysis of the trajectory (representing the user's finger movements) just prior to removal of pressure from the touch input that allows an accurate intended location and direction to be defined, thereby providing a robust and tolerant input method, despite the size limitations imposed on the keypad by the device, and the variability in user fingertip size and placement co-ordination.

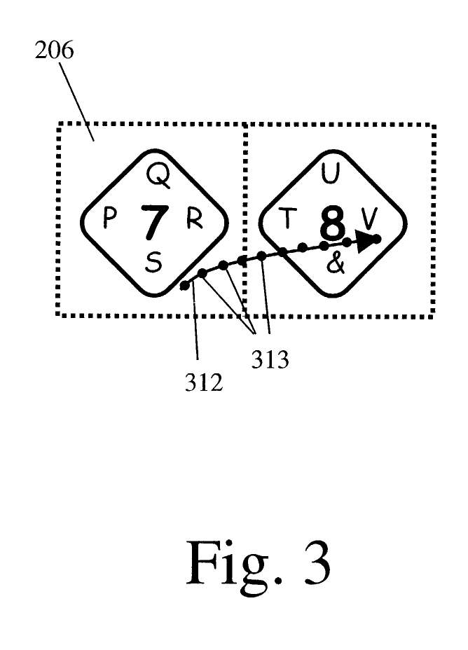

This tolerance is illustrated by reference to FIG. 3, wherein the user, wishing to input the character “R”, may start touch input with a fingertip contact in the general vicinity of the key region 206 associated with the primary character “7”, for example in the lower right hand half of the key region. The user then slides the fingertip in a general direction towards the right, accidentally arcing slightly upwards and into the neighbouring key region associated with “8”. The trajectory 312 comprises a plurality of location points 313, which upon analysis reveal that the user began in the key region 206 associated with the character “7”, and the movement was mostly to the right, therefore the predominant direction is “right”, and the character associated with “right” and key region associated with the primary character “7” is the character “R”. Hence the correct intended character is selected despite the relatively inaccurate placement and movement of the user's finger.

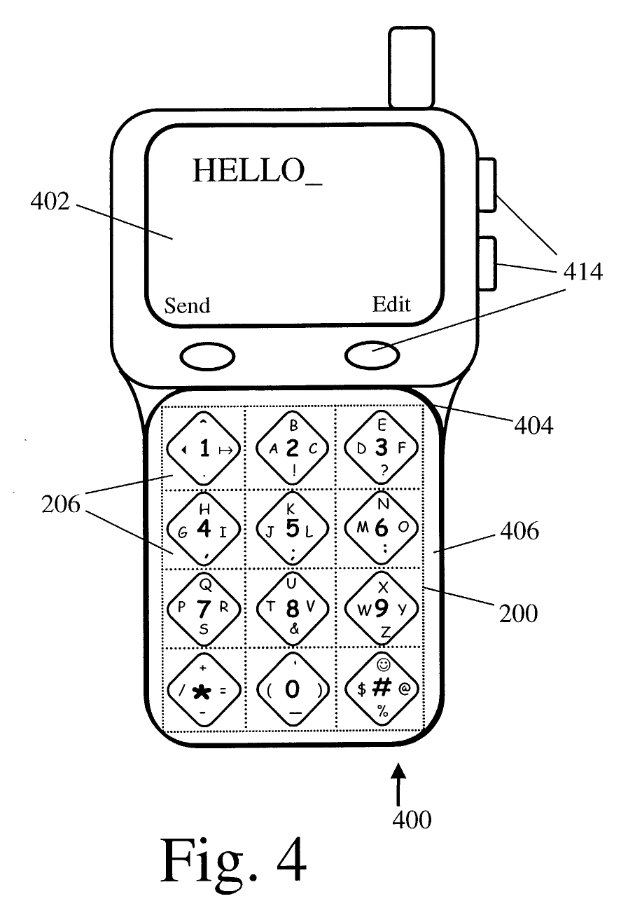

FIG. 4 shows a handheld device 400 such as a portable mobile telephone made in accordance with the present invention, the device comprising display means 402 and a touchpad 406 with a labelled key arrangement 200 comprising key regions 206 associated with characters selectable for input. The touchpad 406 and key arrangement 200 together provide the user with a keypad 404. The device 400 also comprises control buttons 414 which may for example allow powering up of the device and the entering or confirmation of commands. The device further comprises internal electronics which provide for the receipt of and transmission of data together with components adapted for carrying out a method in accordance with this invention.

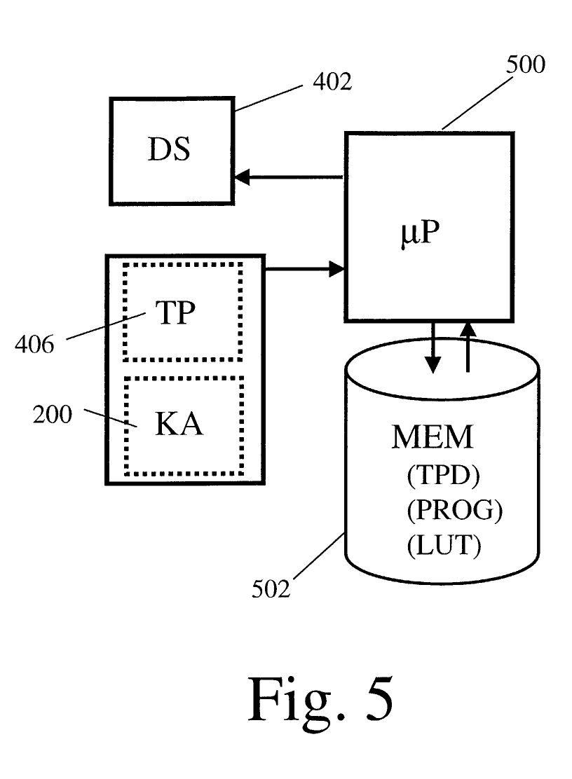

FIG. 5 provides a schematic of the components relevant to the present invention comprising analysing means 500 which in this embodiment is provided in the form of a general purpose microprocessor (μp), although other forms such as a PICmicro® chip or application specific integrated circuit (ASIC) could be employed. Storage means 502 are provided in the form of computer readable storage media such as memory (MEM), the memory able to communicate with the microprocessor 500. A standard component touchpad 406 (TP) such as that produced by Synaptics Inc. of California provides touch input means. The touchpad 406 is able to detect a position within an X-Y matrix of 6,143 by 6,143 positions, providing a single location resolution in excess of 400 dots per centimeter for a typical pad size of approximately 4 cm by 5 cm. In this embodiment the touchpad 406 detects position by a change in capacitance induced by the presence or pressure of an object such as a fingertip, fingerpad, stylus or other suitable pointing device.

The touchpad 406 is positioned on the front of the device 400 and overlaid with a printed key arrangement 200 (KA) such as that shown in FIG. 2. The touchpad is capable of reporting X-Y position data at predetermined “packet rates”. As an example of a suitable rate, that used in this embodiment was eighty packets per second, as this allowed enough points 313 per average user input gesture to be collected to accurately define a trajectory 312.

The memory 502 is arranged so as to be capable of buffering and storing this touchpad data (TPD). Character selection means in the form of a computer program (PROG) is stored in the memory 502, the program comprising program code means which instruct the microprocessor 500 to operate the method described above.

There is also provided, within memory 502, a look-up table (LUT) which provides information to the microprocessor 500 relating to the key arrangement 200 on the touchpad 406.

An example of a look-up table is shown below:

| | | DIR | | | | |
|---|---|---|---|---|---|---|
| KR | KRCS | ND | L | U | R | D |
| 1 | [0, x1, y1, 0] | 1 | <space> | \hat{ } | <CR> | . |
| 2 | [x1, x2, y1, 0] | 2 | A | B | C | ! |
| 3 | [x2, x3, y1, 0] | 3 | D | E | F | ? |
| 4 | [0, x1, y2, y1] | 4 | G | H | I | , |
| 5 | [x1, x2, y2, y1] | 5 | J | K | L | ; |
| 6 | [x2, x3, y2, y1] | 6 | M | N | O | : |
| 7 | (0, x1, y3, y2] | 7 | P | Q | R | S |
| 8 | (x1, x2, y3, y2] | 8 | T | U | V | & |
| 9 | [x2, x3, y3, y2] | 9 | W | X | Y | Z |
| 10 | [0, x1, y4, y3] | * | / | + | = | − |
| 11 | [x1, x2, y4, y3] | 0 | ( | ′ | ) | _{—} |
| 12 | [x2, x3, y4, y3] | # | $ | [symbol] | @ | % |

wherein there is provided information relating key regions (KR 1-12) to a key region co-ordinate system (KRCS), and to characters associated with a direction (DIR), the directions in this embodiment being referred to as “No Direction” (ND), Left (L), Up (U), Right (R ) and Down (D).

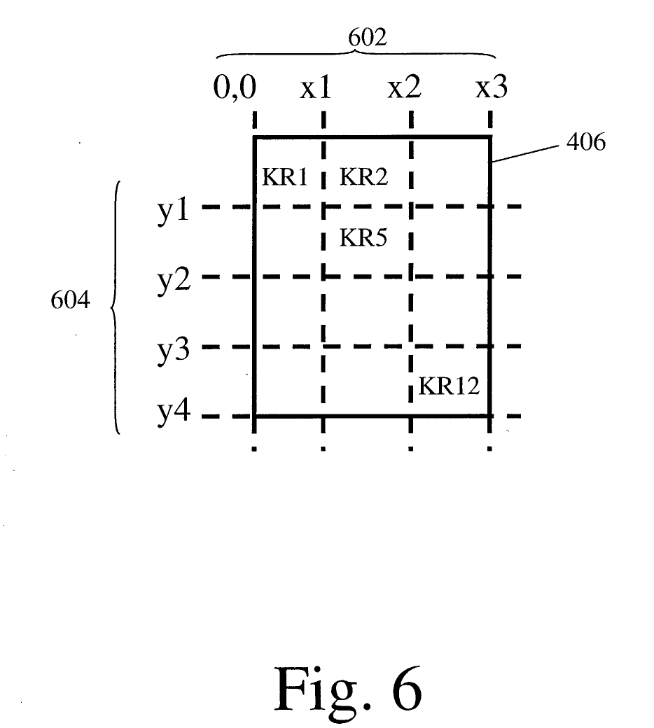

FIG. 6 illustrates the X 602 and Y 604 key region co-ordinate system (KRCS) used, where the top left hand corner of the touchpad 406 represents the origin (0,0), and twelve key regions KR1 to KR12 are defined by setting key region borders at various X and Y positions on the touchpad 406 (herein shown as x1, x2 and x3, y1, y2, y3, and y4). For example, the rectangle representing “KR5” is defined by the lines running from location (x1,y1) to (x2,y1), from (x2,y1) to (x2,y2), from (x2,y2) to (x1,y2) and from (x1,y2) back to (x1,y1). This rectangular key region is represented in the KRCS portion of the look-up table above as [x1,x2,y2,y1]. Hence the microprocessor 502 can test any X-Y position on the touchpad 406 against the key region co-ordinate system and determine within which key region the position lies.

In this embodiment, the touchpad 406 continuously outputs eighty packets of touchpad data (TPD) per second. When there is no touch input, the TPD comprises a steady stream of packets containing “null characters” representing “no input” (e.g. N,N,N,N . . . ). Conversely, upon touch input, the TPD output comprises pairs of number representing the X,Y locations touched on the touchpad. These packets are temporarily stored in memory in a first-in-first-out buffer region, the size of the buffer region in this embodiment chosen to enable the storage of the most recent ten packets of data, which at eighty packets per second represents input occurring over a period of one eighth of a second. The buffer size was determined by analysing the time taken by the user to perform a typical touch, slide and lift input gesture in accordance with a method of this invention. It was determined that one eighth of a second was adequate for storing most typical input gestures on the touchpad 406 providing up to ten valid X-Y data pairs 313 to form a trajectory 312 for analysis by the microprocessor 500. It is apparent that the specific touchpad data rate and resolution, and the physical dimensions of the touchpad 406 and the key arrangement 200 are all factors in the above determinations.

The microprocessor 500 monitors the first-in-first-out buffer for the occurrence of valid X-Y data representing touch input, and upon occurrence the buffered X-Y touch pad data (representing touch input over the previous one eighth of a second) is stored in MEM 502 for analysis.

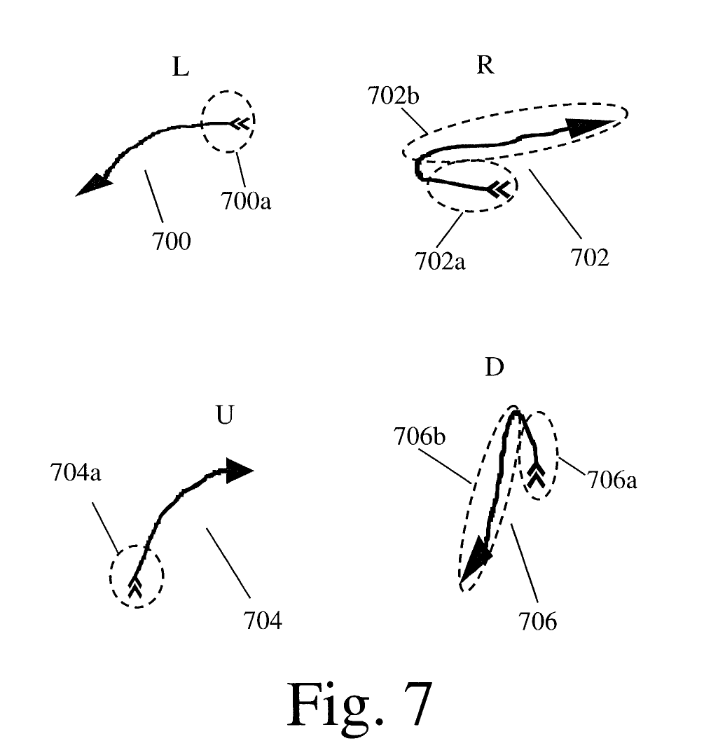

This stored X-Y TPD comprises a plurality of location points 313 which when charted represent a trajectory 312 traced by the user's touch on the keypad. FIG. 7 gives examples of the typical trajectories for Left (L) 700, Right (R) 702, Up (U) 704 and Down (D) 706 input gestures, measured in the development of this embodiment and input by a right handed user (holding the device in the left hand and inputting with a finger of the right hand). These measurements revealed that typical input gestures can be quite complex, in particular it is interesting to note the changes in X and Y direction observed when a user wishes to select a character. The trajectory representing left (L) 700 is distinguished from the down trajectory (D) 706 by having a greater (negative) change in X, although both trajectories exhibit similar negative changes in Y. Similarly, an up (U) trajectory 704 has a greater change in positive Y than a typical right (R) trajectory 702. Threshold values to distinguish trajectory direction were therefore provided in the computer program stored in memory 502.

The microprocessor 500, under the guidance of the computer program analyses the changes in the stored X and Y data across the trajectory, and compares the sign and magnitude of the changes in X and Y to give a predominant direction which is temporarily stored in the memory 502. In the case of a R or D trajectory, a reversal in initial movement of the finger is revealed in the beginning portion of the trajectories 702a, 706a respectively, therefore the remaining portions 702b, 706b are analysed to determine the predominant direction in these instances.

The X-Y data representing the beginning portions 700a, 702a, 704a, 706a of the respective trajectories are subsequently averaged and stored to give a representative location of the user's input. The microprocessor compares the stored representative location with the key region co-ordinate system 602,604 provided by the look-up table to determine the appropriate key region. The microprocessor 500 finally looks up the character corresponding to the direction and key region in the look-up table and instructs the display 402 to display the selected character.

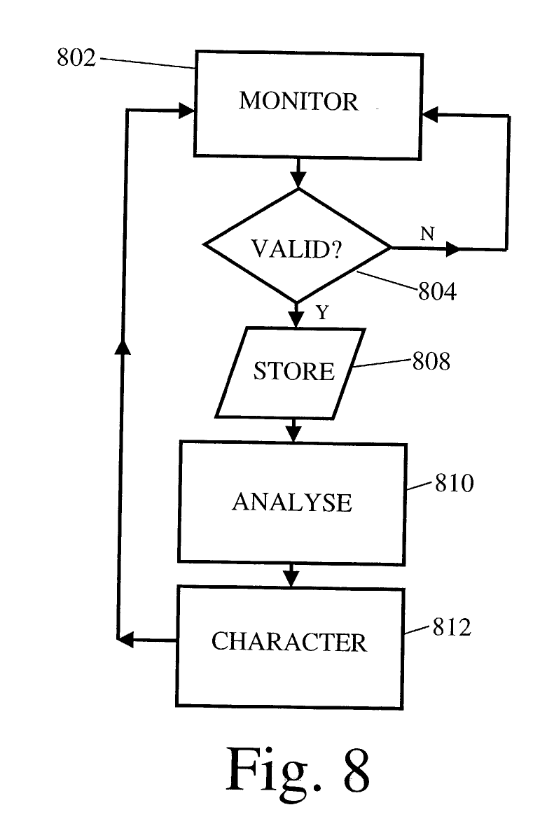

A flow diagram 800 illustrating the main steps of this method is presented in FIG. 8, the method being performed as a loop, wherein: the touchpad data is monitored (MONITOR) 802 and checked for a valid touchpad input (VALID?) 804. When such input is detected,

the buffered touchpad data is stored (STORE) 808;

analysed (ANALYSE) 810 for direction and key region; and subsequently,

a character is returned for display (CHARACTER) 812; after which the method loops back to monitoring the touchpad data 802.

In a further embodiment, to deduce a simple tap (for example quickly tapping the “7” key to enter the primary character “7”), the processor divides the change in X-Y TPD by the number of valid X-Y data pairs in the buffer. This number is then compared with a value and if below the value then a “no-direction” (ND) is stored and used with the look-up table to return the primary character for display. This technique, when used with a value around 20, was determined to be the most accurate in recognising and discerning quick intended “taps” from accidental brushing of the keypad, when for example the device is placed in a bag or pocket of the user.

In a further embodiment valid TPD is stored for analysis after a predetermined timeout period of input has elapsed. In this embodiment it is possible to input characters by placing a finger in a key region, sliding the finger in the direction intended to select the character, and then holding the finger stationary, maintaining input until the timeout period has elapsed and the method analyses the trajectory automatically for key region and direction.

In a further embodiment, it was determined that in general the initial starting position of a user's touch input depends upon the size of the finger used, the eye-hand co-ordination of the user, and also particularly on the direction in which the user anticipates their finger will move.

For instance, a user wishing to select the character “R” using the key arrangement 200 of FIG. 2, will generally begin contact with the key region 206 slightly to the right of the centre character (“8” in this example). Similarly, the average starting point for a character with the “up” direction tends to be above the centre of the associated key region 206. Hence it was determined that the user is inputting as if the key region co-ordinate system itself 602,604 is “offset” up, down, left or right depending upon the user's intended trajectory of input. It is therefore possible to improve character selection accuracy by allowing for this “offset” by providing in memory 502 more than one key region co-ordinate system 602, 604, each associated with a predominant direction.

Therefore, in this embodiment, once a trajectory is analysed and a direction determined, the microprocessor compares the average location against the key region co-ordinate system defined by the direction of the trajectory, improving key region assignment accuracy and hence overall character selection.

In a further embodiment of this invention, threshold values to distinguish trajectory direction for typical gesture inputs by both left handed and right handed users are provided in the computer program stored in memory 502, thereby allowing trajectory analysis to be dependent upon information, provided by a user to the device, regarding whether the user is right handed or left handed.

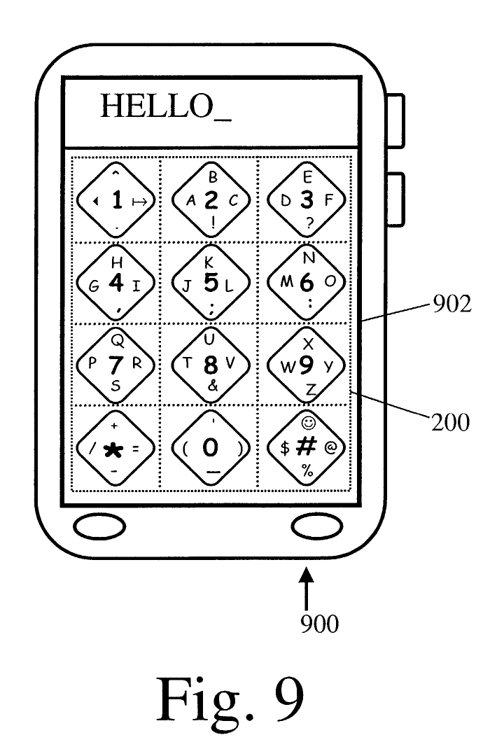

According to a further embodiment of this invention, a handheld computer 900 schematically shown in FIG. 9 is equipped with a touchscreen 902, and a key arrangement 200 such as that shown in FIG. 2 is provided in memory (not shown) and displayed on the touchscreen 902. The displayed key arrangement and touchscreen thereby offer the function of a keypad to the user, and a method of entering text in accordance with the present invention may be implemented as described hereinbefore.

In an enhanced version of this embodiment, the key arrangement 200 is stored in memory in a look-up table capable of customisation by the user, thereby providing a personalised and user preferred keypad when displayed on the touchscreen 902.

In another embodiment of the present invention, a trajectory associated with a character modify function is provided. For example, selection of the character associated with an Up (U) trajectory in key region 1 (KR1), depicted as ˆ in FIG. 4 performs a character modify function on the previously selected character to produce a related character or symbol for input. An example of modified characters (or symbols) selectable with a modify character input is shown in the table below, the table being stored in memory means 502 and accessible by the character selection means.

| Character selected for input | modified related character/symbol |
|---|---|
| A | ÀÁÂÃÄÅ [symbol] a |
| ( | {[<] |
| c | © |
| [symbol] | [symbol] [symbol] [symbol] [symbol] |

The modified characters are associated with the first character input, and repeated selection of the modify function via subsequent touch input causes the previously selected character to be cycled through the modified character list. For example a first selection of a left bracket character ( is achieved on the keypad of FIG. 4 of this invention by touching the 0 (zero) key and wiping to the left. The user then selects the modify function by subsequently touching the appropriate key region 206 (KR 1) and wiping in the appropriate direction (Up). The microprocessor 500 is then redirected to the above look-up table in memory 502, the first modified related character is retrieved and displayed 402 in place of the previously selected character. Hence, in this example the ( first selected is modified to a curly bracket {, another selection of the modify function causes the character displayed to move to the next in the table, in this example a square bracket [ and so on. In this way, characters or symbols related with the previously input character are selectable in an intuitive and accurate fashion.

Another example of related characters or symbols which are commonly used in the art of text messaging on mobile devices is that of emote icons or “smileys”. The suggested keypad layout associated with this invention shown by way of example in FIG. 2, FIG. 4 and FIG. 9 provides a “happy” emote icon or “smiley” on the key depicting a # (hash). An upward gesture on this key returns the happy emote icon [symbol] for input. Other related emote icons such as those representing sadness [symbol] or winking/joking ;-) may be provided by way of the modify function, with the related emote icons being provided in the table as shown by way of example above. Hence, the modify function further extends the available characters beyond those which are displayed on the keypad, to include such examples as related characters (or symbols or icons) with acute or umlaut indications, emote icons or “smileys”, copyright or registered trademark symbols, punctuation symbols/characters and other commonly used variations of characters.

In another embodiment of this invention, the touch input means comprises any component and technique of operation such that co-ordinate positions relating to a touch input are provided. For example well known systems of input using light pens, or other systems utilising ultrasound techniques may be employed to provide the necessary co-ordinates.

Whilst the embodiments described above apply this invention to handheld devices such as portable mobile telephones and a handheld computer, it is apparent to those skilled in the art that the teaching of this invention may also be applied to advantage to other devices and apparatus, such as a touchpad provided within, on or with a personal computer, laptop keyboard, remote control handsets and other devices in general where improved text entry is required. Similarly, the computer program means employed to instruct the analysing means to carry out the analysis of the present invention may be in any convenient high or low level language, microcode or other such embodiments, and the computer program may be stored on any convenient magnetic, optical or other appropriate computer readable storage media.

Additionally, the design of the key arrangement depicting key regions and characters for input may be in any form convenient for the device, language and application chosen, and is not necessarily limited to the arrangement as described hereinbefore. Key and region shapes may be designed to be circular or oval for instance, without departing from the spirit and scope of this invention.

From reading the present disclosure, other modifications will be apparent to persons skilled in the art. Such modifications may involve other features which are already known in the design, manufacture and use of devices, and component parts thereof, offering text input and which may be used instead of or in addition to features already described herein.

In the present specification and claims the word “a” or “an” preceding an element does not exclude the presence of a plurality of such elements.

Further, the word “comprising” does not exclude the presence of other elements or steps than those listed.

1. A method for the selection of an input character to a device comprising touch sensitive input means; said method comprising the steps of:
defining a trajectory comprising a plurality of location points in response to touch input;
analysing the trajectory to determine a predominant direction and a representative location of said trajectory; and
selecting a character for input depending on the location and direction of said trajectory.

2. A method as claimed in claim 1, wherein the representative location is determined by analysis of a portion of the trajectory.

3. A method as claimed in claim 1, wherein the predominant direction is determined by analysis of a portion of the trajectory.

4. A method as claimed in claim 1, wherein the touch sensitive input means comprises a plurality of key regions together providing a key arrangement, and the method comprises associating the representative location with a particular key region.

5. A method as claimed in claim 4, wherein each key region is associated with a plurality of characters, each of which characters is further associated with an assigned predominant direction.

6. A method according to claim 1, wherein the selected character is modified to a related character in response to the direction and location of a trajectory determined from subsequent touch input.

7. A device for receiving character input, comprising touch sensitive input means, means for defining a trajectory comprising a plurality of location points in response to touch input, analysis means for analysing the trajectory to determine a predominant direction and a representative location of the trajectory, and character selection means responsive to the determined location and direction for determining an input character.

8. A device as claimed in claim 7, wherein the touch sensitive input means comprises a plurality of key regions together providing a key arrangement, and wherein the key arrangement includes characters capable of input to the device.

9. A device as claimed in claim 8, further comprising storage means for storing the key arrangement, said means providing a representative location associated with a key region and a predominant direction associated with a character to the character selection means.

10. A device as claimed in claim 9, wherein at least one key region and character correspond to a modification input, wherein related characters to those characters associated with a key region and a predominant direction are provided in the storage means, said related characters being selected for input to the device upon the determination by character selection means of said modification input.

11. A device as claimed in claim 9, wherein means are provided for selecting a key region co-ordinate system corresponding to the key arrangement and depending on the determined predominant direction, and for identifying a key region from the selected key region co-ordinate system based on the representative location.

12. A device as claimed in claim 11, wherein means are provided for determining the hand used by a user to input characters, and wherein the analysis of the trajectory is varied depending upon said determination.

13. A device as claimed in claim 12, wherein the touch sensitive input means comprises a touchpad labelled so as to depict the key arrangement on a surface of the device.

14. A device as claimed in claim 9, wherein the touch sensitive input means further comprises display means having a touch sensitive surface, the display means being operable to display the stored key arrangement.

15. A device as claimed in claim 14, wherein means are provided for altering the stored key arrangement, thereby providing a customisable key arrangement.

16. A computer program comprising program code means for performing all of the steps of claim 1 when the program is run on a device comprising analysis means.

17. A computer program product comprising program code means stored on a computer readable medium for performing the method of claim 1 when the program product is run on a device comprising analysis means.
